(19) United States
(12) Patent Application Publication
(10) Pub. No.: US 2012/0265564 A1
(43) Pub. Date: Oct. 18, 2012

(54) SYSTEMS AND METHODS FOR ASYNCHRONOUSLY SELLING EVENT TICKETS

(75) Inventors: James Christopher McCARTHY, Pasadena, CA (US); Robert Leonard GRAFF, Altadena, CA (US); Christine Michelle DETERS, Los Angeles, CA (US); William Overturf CLARK, Portland, OR (US); Bryan Clifton LILES, Glen Burnie, MD (US)

(73) Assignee: GOLDSTAR EVENTS, INC., Pasadena, CA (US)

(21) Appl. No.: 13/445,193

(22) Filed: Apr. 12, 2012

Related U.S. Application Data
(60) Provisional application No. 61/475,556, filed on Apr. 14, 2011.

(51) Int. Cl. G06Q 30/06; G06Q 10/02

(52) U.S. Cl. 705/5; 705/26.1; 705/27.1

(57) ABSTRACT

Systems and methods for a group of people to purchase tickets are described. The group of people does not necessarily have to purchase such tickets at the same time, yet are able to sit together at the event as a group.

### CROSS REFERENCE TO RELATED APPLICATIONS

The present application claims priority to U.S. Provisional Patent Application No. 61/475,556, filed on Apr. 14, 2011, which is incorporated herein by reference in its entirety.

### FIELD

The present disclosure relates to selling event tickets to a group of buyers. In particular, it relates to systems and method for asynchronously selling event tickets.

### BACKGROUND

Among many methods, an example of a method for consumers to purchase event or attraction tickets is through the use of personal computers connected to an Internet network to a ticket seller and/or supplier. However, when a plurality of buyers desire to attend an event together, and therefore desire to purchase tickets for such event, one person from the group might take charge and purchase tickets for the entire group. When such event requires seat assignments, all of the tickets for all persons in the group desiring to sit together must be purchased at the same time in a single transaction. In such case, one person may end up initially paying for the tickets for the entire group, and then being reimbursed later by their friends.

Moreover, in cases where additional friends decide that they desire to attend, after the tickets are purchased, they risk a situation where they may not be able to sit together.

### SUMMARY

According to a first aspect, a computer-based method of selling tickets to a plurality of buyers is described, the method comprising: providing a seller with a plurality of event tickets to be sold; providing a server based Internet website for selling the plurality of the event tickets; a first person purchasing one or more event tickets by visiting the server based Internet website using an Internet browser from a client terminal connected to an Internet network; the server storing the event ticket information of the first person in a will-call database; the server providing a purchase identifier to the first person after the purchasing of the one or more event tickets, wherein the purchase identifier is linked to the event ticket information of the first person; sharing the purchase identifier with at least one other person, the at least one other person desiring to purchase a same event ticket and desiring to sit with the first person; the at least one other person visiting the server based Internet website by using the purchase identifier, wherein the server based Internet website identifies the at least one other person as desiring to sit with the first person according to the purchase identifier; and the at least one other person purchasing the event ticket while visiting the server based Internet website, such that the event ticket information of the at least one other person is stored in the will-call database comprising instructions to seat the first person and the at least one other person together.

According to a second aspect, a computer server for selling tickets is described, the server comprising: a website adapted to sell one or more event tickets to a plurality of buyers, wherein the website is configured to enable a first buyer to purchase one or more event tickets, wherein a purchase identifier is provided to the first buyer upon purchase, such that the purchase identifier is shareable with at least one other buyer; and a will-call database comprising information of the first buyer and the at least one other buyer, wherein the will-call database is configured to provide a will-call list to a ticket supplier of the event, the will-call list comprising instruction to seat the first buyer with the at least one other buyer.

According to a third aspect, a system for selling tickets over an Internet network is described, the system comprising: a server connected to the Internet network, the server comprising a website adapted to sell one or more event tickets to a plurality of buyers; a first client terminal connected to the Internet network and adapted to be used by a first buyer, the first client terminal comprising hardware and software, such that the first buyer is able to visit the website on the server; the website adapted to enable the first buyer to purchase an event ticket, such that a purchase identifier is provided to the first buyer, wherein the purchase identifier is shareable with at least one other buyer; one or more additional client terminals connected to the Internet network, the one or more additional client terminals adapted to be used by the at least one other buyer to purchase a same event ticket as the first buyer and desiring to sit with the first buyer, the one or more additional client terminals comprising hardware and software, such that the at least one other buyer is able to use the purchase identifier to visit the website, wherein the purchase identifier identifies the at least one other buyer as desiring to sit with the first buyer; and a will-call database associated with the server comprising information of the first buyer and the at least one other buyer, wherein the will-call database is configured to provide a will-call list to a ticket supplier of the event associated with the event ticket comprising instruction to seat the first buyer with the at least one other buyer.

According to a fourth aspect, a method of sharing a purchase identifier among a plurality of buyers is described, the method comprising the steps of: generating, by a server, the purchase identifier when a first buyer purchases one or more event tickets, the purchase identifier adapted to associate one or more additional buyers with the first buyer; providing, by the first buyer, the purchase identifier to the one or more additional buyers; purchasing, by the one or more additional buyers, one or more event tickets using the purchase identifier; and associating the one or more additional buyers with the first buyer, wherein the associating comprises assigning seating for the first buyer with the one or more additional buyers.

According to a fifth aspect, a method for selling event tickets is described, the method comprising: a supplier allocating a plurality of tickets to a seller, the seller selling the plurality of tickets on a webpage accessible by buyers from the Internet, wherein each ticket of the plurality of tickets is a reservation for a seat at the event; a server selling at least one ticket of the plurality of tickets to a first buyer thus reserving a seat from the allocated plurality of tickets without a specific seat assignment; the server selling at least one additional ticket of the plurality of tickets to at least one additional buyer thus reserving a seat from the allocated plurality of tickets without a specific seat assignment, wherein the at least one additional buyer desires to sit with at least the first buyer; stopping selling the plurality of tickets; and the seller or the supplier assigning a specific seat to each of the plurality of tickets sold to the first buyer and the at least one additional buyer upon stopping selling the plurality of ticket, thus assigning seats according to the seating assignment desires by the first buyer and the additional buyers.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a diagram of a ticket seller's server being accessible by a plurality of client terminals.

FIG. 2 shows exemplary information provided by the ticket seller's server and displayed on a group leader's client terminal after the group leader purchases tickets.

FIG. 3 shows an exemplary webpage for the group leader to share a purchase identifier with others.

FIG. 4 shows exemplary information provided by the ticket seller's server and displayed on a group leader's client terminal when the group leader visits the webpage by using the shared purchase identifier.

FIGS. 5-6 show exemplary information provided by the ticket seller's server and displayed on additional buyers' client terminal after the additional buyers join the group by purchasing tickets.

FIG. 7 shows an exemplary will-call list generated by the ticket seller's server.

FIG. 8 shows a flow chart of methodical steps of selling tickets according to embodiments of the present disclosure.

FIGS. 9-10 show flow charts of methodical steps of selling tickets according to alternative embodiments of the present disclosure.

FIG. 11 is a high level block diagram of various embodiments of the present disclosure.

### DETAILED DESCRIPTION

An embodiment of the present disclosure describes methods for a ticket seller (e.g., event ticket seller) to sell a plurality of tickets while allowing each person to pay for their own ticket, allowing each person to purchase the ticket at different times from one another, and yet, be able to sit together. The terms “sit” or “sitting” as used herein in the present disclosure is not necessarily limited to just the physical act of “sitting” (e.g., sitting in a chair or floor) but can also include other positions performed by the body such as standing. The phrases “sit with” or “sit together” is intended to include, but not be limited to being immediately adjacent to one another, but can also include being in the vicinity of one another, such as, for example in front of or behind one another.

Herein in the present disclosure, the term “event” is intended to refer to concerts, sporting games, movies, or any event where an attendee is provided an assigned seat, section or region. It can also include flight reservations (e.g., airline tickets) or train reservations. Such seating assignment can be arranged, for example, by assigning the seats when the attendees purchase tickets to the event or when the attendees arrive at the event.

Tickets to events can be purchased using a variety of available methods. One such method can be to purchase tickets in-person from a ticket seller or a ticket supplier. When a buyer desires to attend the event with, for example, friends, the group of friends would typically purchase their tickets together in order to ensure their assigned seats are next to each other.

In the present disclosure, the term “ticket supplier” is defined as the party that generates and supplies tickets to a particular event. The term “ticket seller” is defined as the party that sells tickets obtained from the ticket supplier. For example, the ticket supplier can allocate a certain amount of tickets to be sold by the ticket seller. The ticket seller does not necessarily have to have the tickets on hand but instead is able to sell them on behalf of the ticket supplier. The term “ticket seller” can be used interchangeably with the term “ticket reseller”.

Typically, when a first buyer visits a ticket seller's Internet website to purchase a ticket, and a second buyer (e.g., the first buyer's friend) desires to purchase a ticket to the same event and sit next to the first buyer, there is no guarantee that the first buyer and the second buyer will get seating assignments that are next to each other. The likelihood of the two buyers being able to sit next to each other depends on factors such as, the time period that has passed between the first buyer and the second buyer purchasing their tickets, the popularity of the event, and the availability of seats. Therefore, it can become burdensome to the buyers, for example, since one buyer may have to buy tickets for the entire party to guarantee seats together and then get reimbursed later. It can also be burdensome to the buyers when some people in the party desire to attend an event (thus desire to purchase tickets before they are sold out) while others in the party are still undecided, thereby causing the entire party to delay the purchasing of their tickets. Such delay can cause the tickets to become sold out by the time everyone in the party has made their decisions. Additionally, it can be burdensome when some people decide they want to join the party after the tickets have already been purchased.

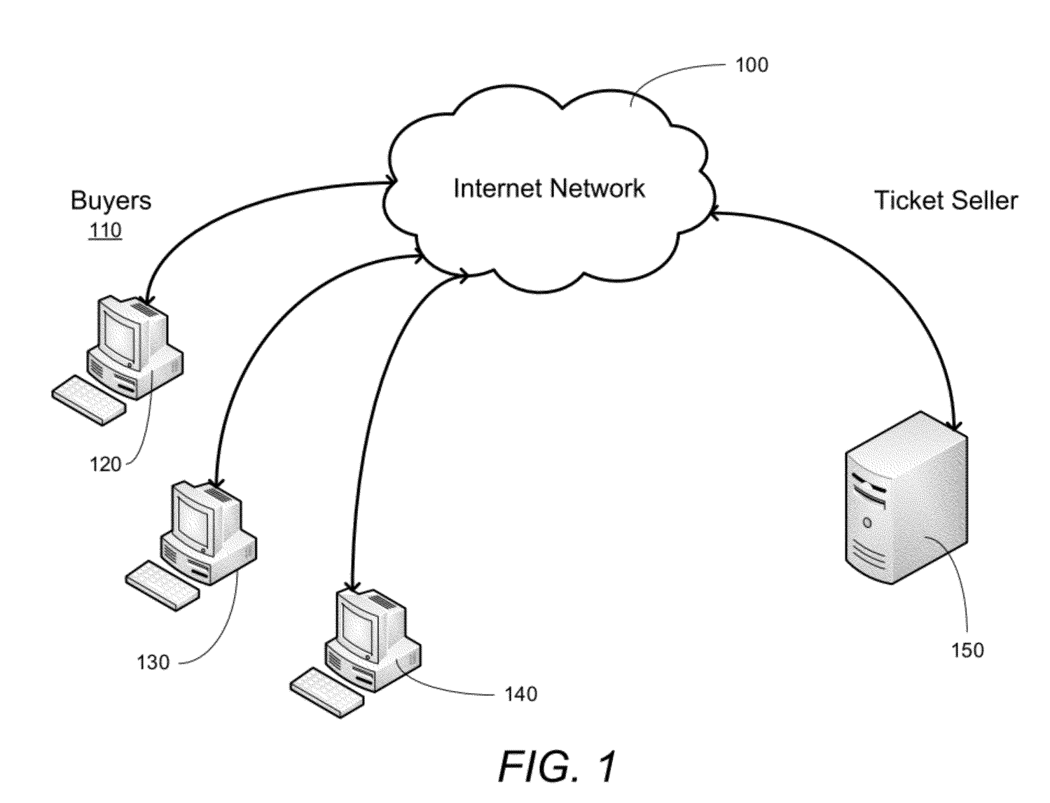

In an exemplary method of purchasing tickets, buyers can purchase tickets by communicating with the ticket seller remotely, for example by way of Internet (100) as shown in FIG. 1, instead of in-person. The embodiments of the present disclosure describe methods for a group of buyers (110) to purchase event tickets that allow the group of buyers to sit next to each other, without necessarily requiring the group of buyers to purchase all of the tickets at the same time.

In an embodiment of the present disclosure, a ticket seller provides a website for selling event tickets. The website can be located on a server (150) provided by the seller that is connected to the Internet (100) so that any person that desires to purchase tickets can access the website through a remotely located personal computer (120, 130, 140) using an Internet browser. Such remotely located personal computer can be interchangeably referred to as a client terminal. “Event tickets”, as referred to herein in the present disclosure is intended to refer to, not only physical tickets for an event, but can also include ticket vouchers, ticket reservations, ticket coupons, virtual tickets, electronic tickets, e-tickets and/or any other ticket equivalents that will allow the event ticket holder enter, attend, sit or stand at the event.

When a first buyer desires to purchase one or more tickets, the first buyer can visit the ticket seller's website, select a desired event and a desired number of tickets, and purchase the tickets, for example, with a credit card. Once the purchase transaction is accomplished, the first buyer has paid for, and is guaranteed with the selected number of tickets to the event, and a so-called group is formed where the first buyer becomes the group leader. From here on in the present disclosure, the first buyer will be interchangeably referred to as the group leader.

The seller's server can comprise a will-call database that tracks the number of tickets each buyer has purchased and the remaining number of tickets that are still available. A will-call database can be defined as a database located in a data storage medium on a computer, such as the server, comprising identifying information (e.g., names) of the ticket buyers according. Such will-call database can be used to create or generate a will-call list, which will be explained later.

Once a purchase transaction takes place, the will-call database is updated with the buyer's information (e.g., name, purchase number, etc.). The server then generates a purchase identifier so that if additional buyers (e.g., friends of the group leader) desire to attend the particular event as part of the group leader's party, the additional buyers can visit the seller's website at a later time and purchase tickets by using the provided purchase identifier. The purchase identifier can be, for example, a unique purchase uniform resource locator (URL) or an alphanumeric code.

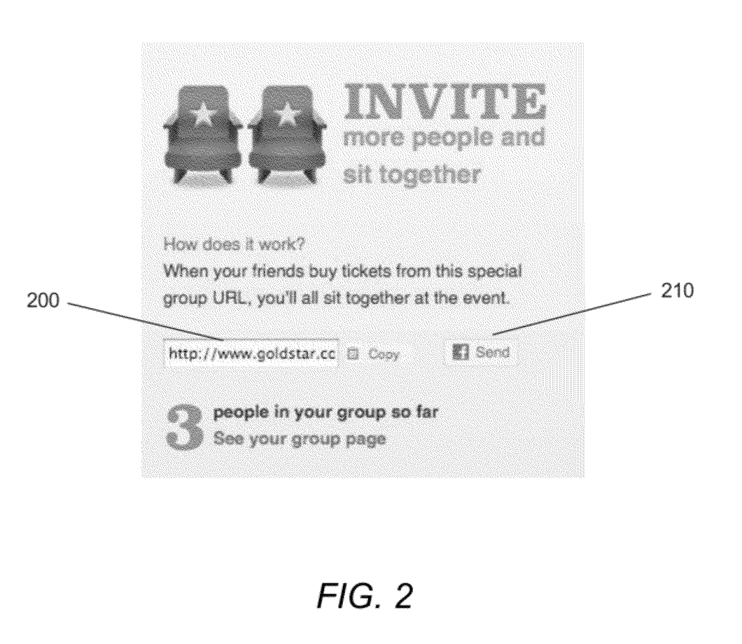

More specifically, the group leader is provided with the purchase identifier (200) (shown as a unique purchase URL) as shown in FIG. 2, when the group is formed (e.g., once the first purchase transaction is completed by the group leader). The group leader can provide the purchase identifier (200) to anybody the group leader so desires to share with. Example of methods that the group leader can share the purchase identifier (200) can include, but are not limited to, emails, instant messages, posting on blogs or social media websites (210). By providing such purchase identifier (200), the group leader is able to invite others to purchase tickets to attend the event as part of the group leader's party. As a part of the group leader's party, they will be able to sit together.

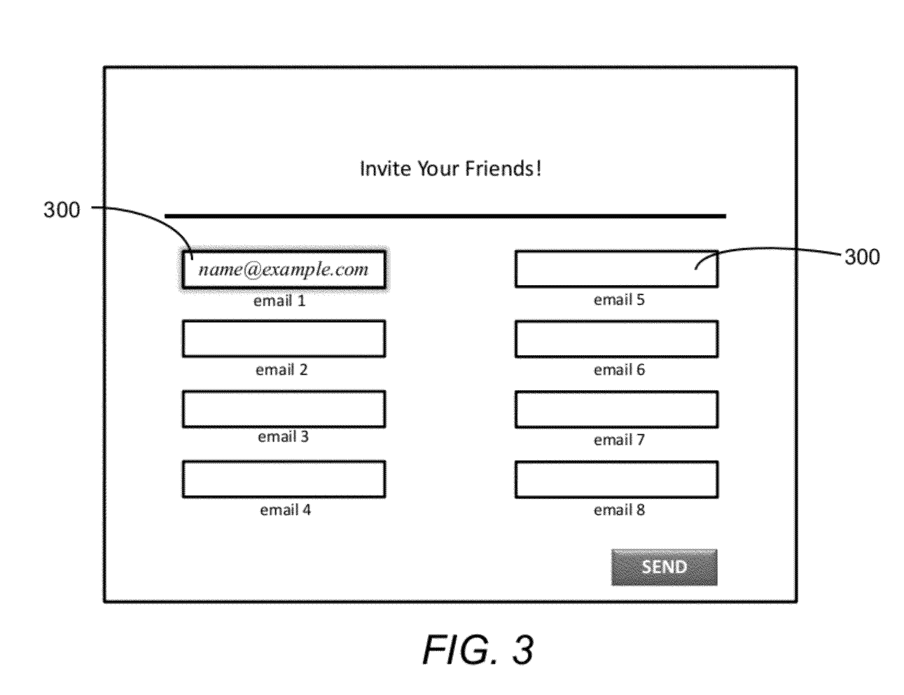

According to another embodiment of the disclosure, the server may be configured to share the purchase identifier on behalf of the group leader. More specifically, when the group leader purchases one or more tickets, the group leader can be provided with an option to enter email addresses of additional buyers that the group leader desires to share the purchase identifier with. By way of example and not of limitation, during the checkout process while purchasing the event tickets as shown in FIG. 3, the group leader can enter email addresses of the additional buyers (300) on the website. The server can be configured to automatically send an email comprising the purchase identifier to additional buyers. In some embodiments, the group leader can enter SMS phone numbers or social media/instant messenger usernames of the additional buyers for the server to send the purchase identifier to.

In some cases, the group leader my desire to invite a limited number of people to attend the event as part of the group leader's party. According to another embodiment of the disclosure, the server can provide the group leader with a finite number of distinct purchase identifiers configured for one-time use only. In other words, each of the distinct purchase identifiers can be configured to be used only once, so that once the recipient of the purchase identifier uses the purchase identifier to purchase the event ticket (thus joining the group leader's party), the same purchase identifier is no longer usable to purchase additional event tickets and join the group leader's party. Consequently, the recipient is discouraged from further sharing the same purchase identifier and inviting other people to purchase event tickets as part of the group leader's party, whom may otherwise not be invited by the group leader.

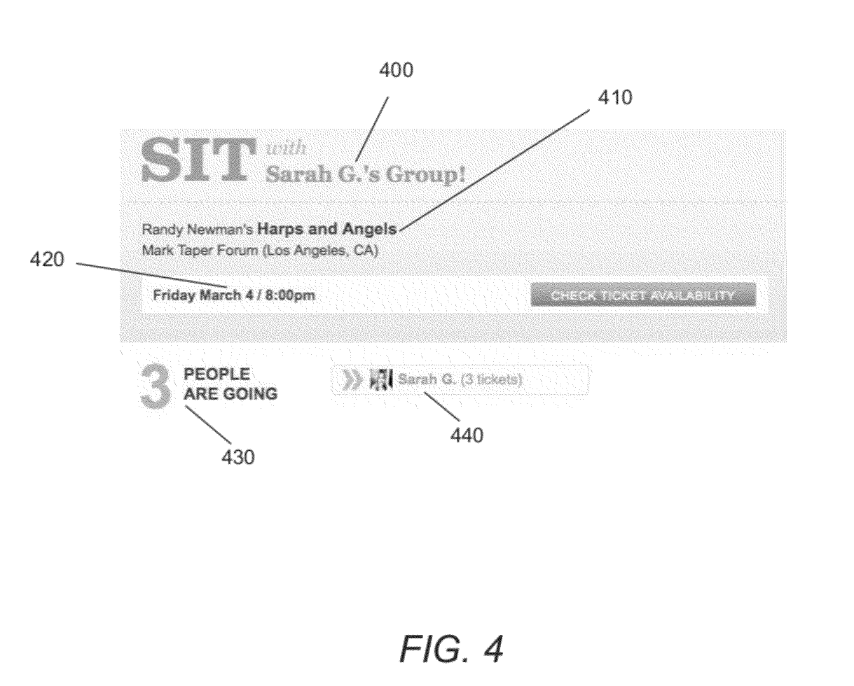

In the case that the purchase identifier is a unique purchase URL, when the additional buyers visit the seller's website using the unique purchase URL provided by the group leader, the additional buyer is directed to a webpage on the seller's server that shows information about the particular event to which they were invited. In the case that the purchase identifier is an alphanumeric code, the additional buyer will visit the seller's webpage, for example, manually (instead of being directed by a hyperlink) and can be prompted to enter the alphanumeric code. Entering such unique purchase alphanumeric code will bring the additional buyer to the webpage on the seller's server that shows information about the particular event to which they were invited. For example, as shown in FIG. 4, the group leader's name (400), event name (410), date of the event (420), total number of people attending the event in the group (430), and the names of the people attending (440) and sitting together, are provided by the server and displayed on the client terminal. The additional buyers can then select the number of tickets they desire to purchase, perform the purchase transaction, and the will-call database on the server will be updated with the additional buyers' names, the number of desired tickets, and an indication that such additional buyers are part of the group and should thus be seated together.

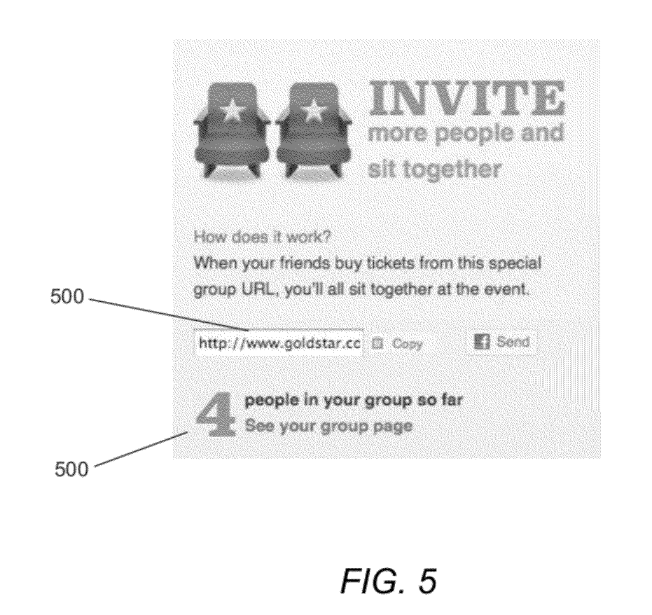

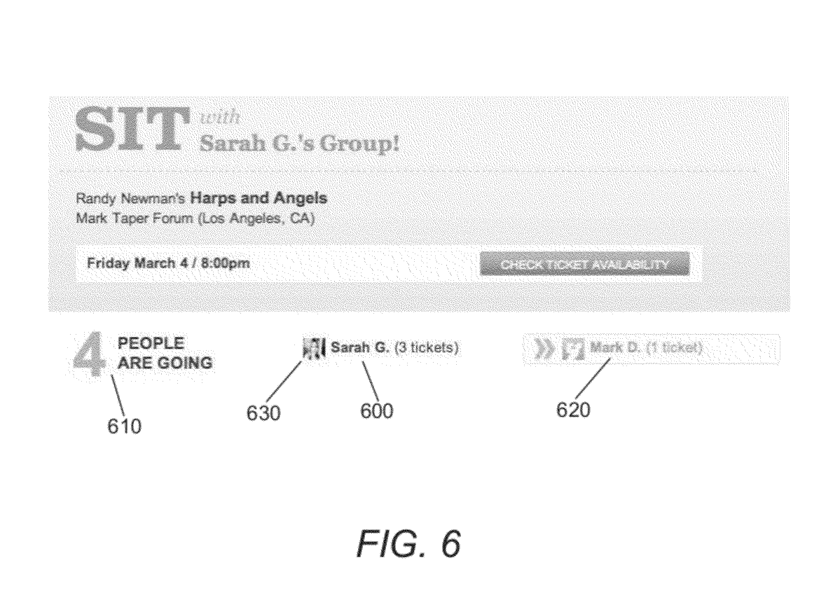

Whenever the additional buyers purchase tickets, the server provides updated information on the buyer's client terminal by displaying the total number of people that are now in the updated group (500) as shown in FIG. 5, and also provide the same unique purchase URL (510) that these additional buyers were initially provided by the group leader. The additional buyers can use this unique purchase URL (510) to invite more people (e.g., friends) to attend the event with the same group. If the unique purchase URL is now accessed via the Internet, the server will provide updated information on the client terminal by displaying the number of people attending (610), and the names of the people in the group who purchased tickets (600, 620), as shown in FIG. 6. An icon or a picture (630) (e.g., avatar) corresponding to the group leader or the additional buyers can be displayed next to each person's name. In some cases, the group leader can choose to display each buyer's full names, partial names (e.g., first name only, last name only, initials only), or no names at all, for privacy concerns.

In some cases, a ticket supplier, and thus a ticket seller may offer multi-tiered/multi-priced event tickets such as, for example, orchestra section seating for $200 and a balcony section seating for $100. According to an embodiment of the disclosure, the group leader can buy one or more event tickets for a particular tier, for example, the orchestra section. When the group leader invites additional buyers by sharing the purchase identifier, the additional buyers can be offered to join the group leader in the same tier (e.g., orchestra section), or be provided with the option to purchase tickets in a different tier (e.g., balcony section). As more and more additional buyers visit the webpage by using the shared purchase identifier, each of the additional buyers can choose the desired tier and sit together with the group. In such multi-tiered case, the initial group can form subgroups for each tier of seating, such that each buyer in the subgroup may be assigned seating together but the two subgroups may not necessarily be assigned seating together.

In yet another embodiment of the disclosure in which a multi-tiered/multi-priced event tickets is available, if the seating section in which the group leader has already purchased the event ticket is no longer available (e.g., sold out), the additional buyers can be provided with an option to purchase event tickets in another section, thus forming a subgroup in such other section. When further additional buyers use the shared purchase identifier to purchase event tickets, such additional buyers will be directed to purchase event tickets for the new subgroup tier. Additionally, any buyer who purchased their event tickets before the tickets for the initial tier were sold out can be notified and provided with an option to switch seating sections to be able to sit with the rest of the additional buyers. In such case, if the buyers desire to switch to a different tier and such switching results in a price difference, such difference in price can be settled. In other words, if the new tier that the buyer is switching to is more expensive, then the buyer will be required to pay the difference, and if the new tier that the buyer is switching to is less expensive, then the buyer will receive a refund from the ticket seller. The buyer can receive such refund in other forms that have monetary value, such as, gift cards, store credit or points.

In some embodiments, when the additional buyers use the purchase identifier to visit the seller's webpage to purchase event tickets, the webpage can have a message board for the group leader and/or each of the additional buyers to communicate with each other. For example, the group leader and/or each of the additional buyers can post information pertaining to planning or preparation for the event.

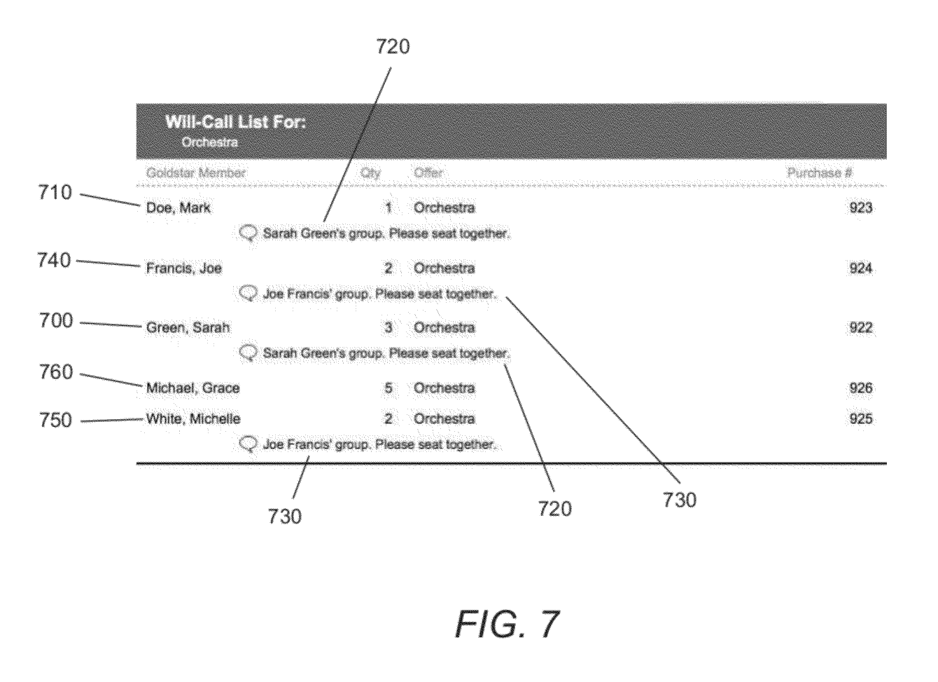

Once ticket sales for the particular event ends, a will-call list is produced from the will-call database and provided to the ticket supplier. FIG. 7 shows the will-call list showing the group leader's purchase order (700) and the additional buyer's order (710). A note (720) is added to each purchase order that is a part of the same group to indicate that tickets for all members of the same group should be seated together. A group leader for a second group (740) separate from the first group leader (700) is also shown, with an additional buyer (750) for the second group leader. Accordingly, a note (730) is added to each purchase order for the second group, whereas a buyer who does not belong to any group (760) is listed without a note. The will-call list can be sent to the ticket supplier, for example, by way of an email, a facsimile, or an XML feed, or any other methods for sending lists known by those skilled in the art. The ticket supplier issues tickets according to the notes on the will-call list to ensure all members of the same group are seated together. Ticket sales can end, for example, at a predetermined amount of time before the start of the event, to ensure sufficient time for the ticket supplier to issue tickets according to the noted instructions. The issued tickets can be kept at a will-call ticket window, by way of example, and not of limitation, by the ticket supplier at the event site such that the buyers, including the group leader can pick up their reserved tickets prior to start of the event.

In an alternative embodiment, the buyers can receive the tickets, when issued, using one or more electronic means such as emailing of an electronic ticket, allowing the buyers to download the electronic ticket or by sending an electronic ticket by way of mobile handheld devices (e.g., cell phones, smart phones, etc.). In yet another embodiment, the buyers can have the tickets physically delivered, for example, by way of a delivery courier or the postal service.

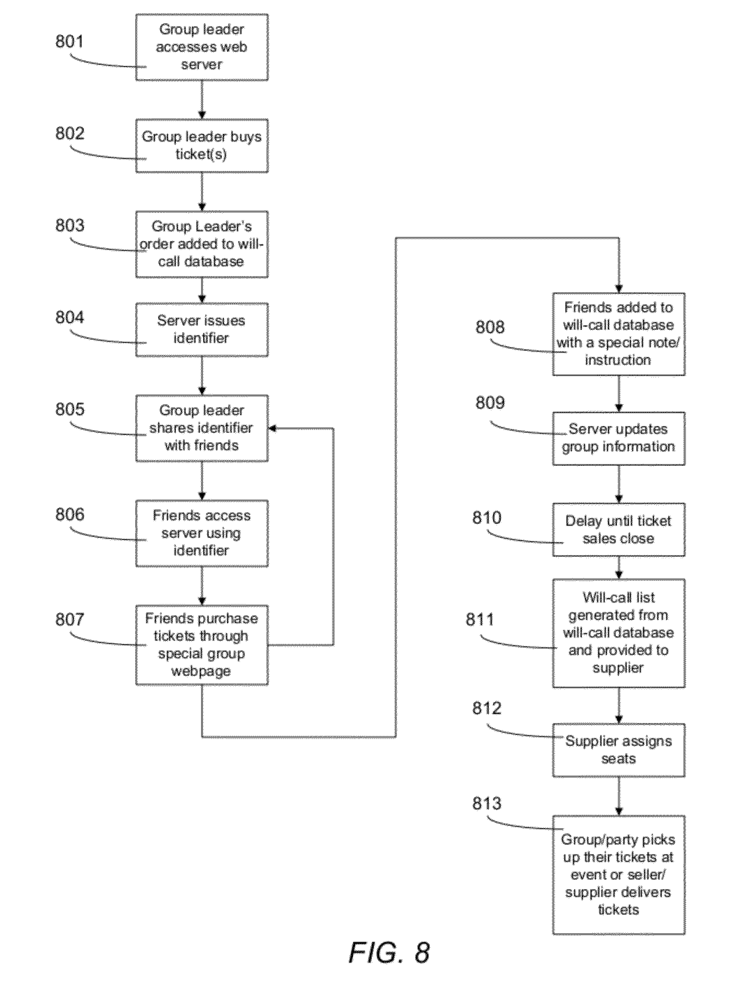

FIG. 8 shows an example methodical step of the embodiments described in the present disclosure. A group leader accesses the ticket seller's server via the Internet (801) and chooses a date and an event they wish to attend. The group leader selects a desired number of tickets and purchases the tickets (802). The group leader's name and the number of purchased tickets are added to the will-call database (803). The ticket seller's server generates a purchase identifier (804) so that the group leader can share the group's purchase identifier (805) with others who would like to attend the event together as a group. Recipients of the group's purchase identifier can visit the seller's webpage on the server (806), which can recognize that the purchase identifier belongs to a particular group and allow them to purchase tickets (807). The additional tickets purchased are added to the will-call database with a note explaining that these tickets are part of a particular group (808), thus ensuring the ticket supplier assigns seats together. Once other buyers join the group, the group's information is updated on the ticket seller's server (809) to reflect the most updated total number of attendees. After a delay of some amount of time (810) (e.g., once ticket sales end), a will-call list is created from the will-call database on the server and provided to the ticket supplier (811) so that the ticket supplier can assign seats (812) and issue tickets according to instructions on the will-call list. The group leader and/or the additional buyers can pick up their tickets at the will-call window from the ticket supplier (813).

According to another embodiment, instead of the ticket supplier assigning seats according to instructions provided in the will-call list generated by the ticket seller, the ticket seller can assign seats for each of the buyers that have purchased event tickets. In order to ensure that the group leader's party can be assigned seats together (e.g., adjacent to one another), seating is assigned by the ticket seller after a certain amount of time has passed (e.g., after the tickets are sold out or once ticket sales is closed), thus allowing time for all additional buyers that are desiring to join the group leader's party to still purchase event tickets and join the group. Once the ticket seller assigns seats, such seating assignments can be entered into the will-call database, an updated will-call list can be generated and provided to the ticket supplier.

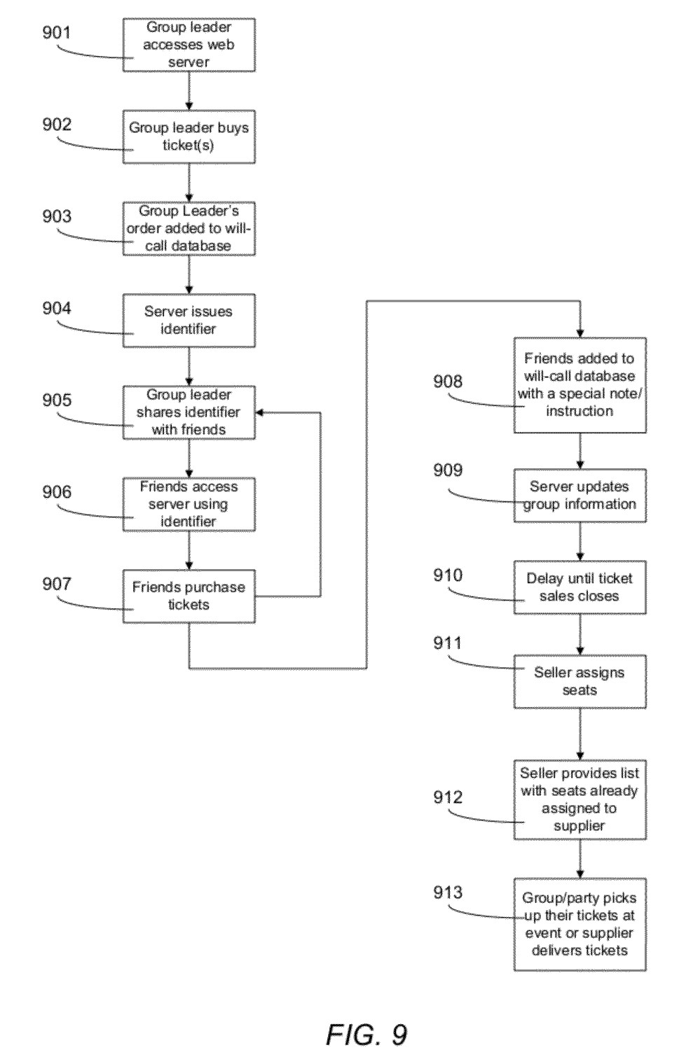

FIG. 9 shows example steps according to another embodiment described in the present disclosure. Although steps (901)-(909) are similar to FIG. 8, however, differently from FIG. 8 after the group's information is updated on the ticket seller's server (909) to reflect the most updated total number of attendees, after a certain delay in time (910) (e.g., ticket sales closes for the event) after the tickets are sold, the ticket seller assigns seats for the attendees (911). The ticket seller assigns seats by referring to the will-call database to determine whether or not the attendees have purchased the event tickets by using the purchase identifier provided by the group leader, or for any other special instructions.

The embodiments described in the present disclosure provide examples for cases where the ticket seller is different from the ticket supplier. Therefore, although the tickets are not issued to the buyer at the time of purchase, the buyer's ticket is paid for and guaranteed.

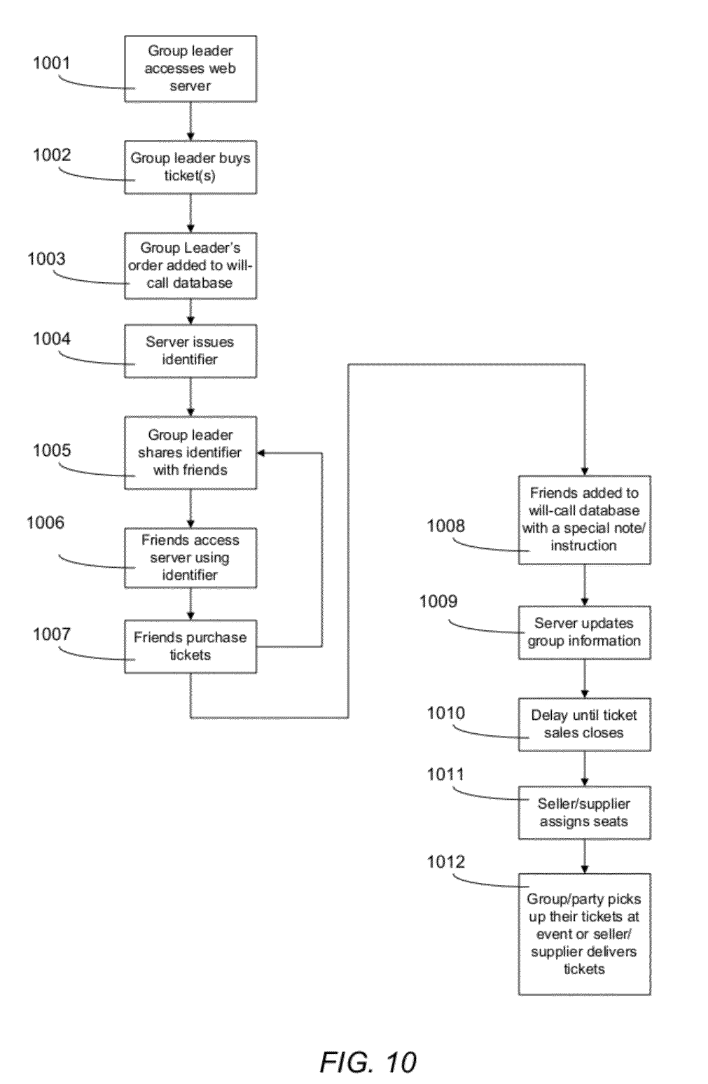

Although the methods described in the present disclosure describe methods for a ticket seller, a person skilled in the art would understand that the methods described herein can be applicable to a ticket supplier who is also the ticket seller (e.g., an event holder (supplier) sells their own tickets via their own webpage). For example, FIG. 10 shows such case when the ticket supplier is also the ticket seller. Although steps (1001)-(1011) are similar to FIG. 9, however, differently from FIG. 9, FIG. 10 shows that after the ticket seller (who is also the supplier in this case) assigns seats for the attendees (1011) according to the ticket seller's own will-call list obtained from the will-call database, the ticket seller/supplier provides the tickets (with assigned seats) directly to the buyers. In such case where the ticket supplier is also the ticket seller, although a will-call list can be used, the information from the will-call database can be used directly without necessarily having to generate and use a will-call list. As described according to various embodiments of the present disclosure, the ticket supplier can deliver, for example, physical event tickets (e.g., paper tickets) directly to the buyers by way of a delivery courier or postal service, or deliver a virtual ticket (e.g., electronic tickets) by way of email, download over the Internet or mobile handheld devices (e.g., cell phones, smart phones, etc.).

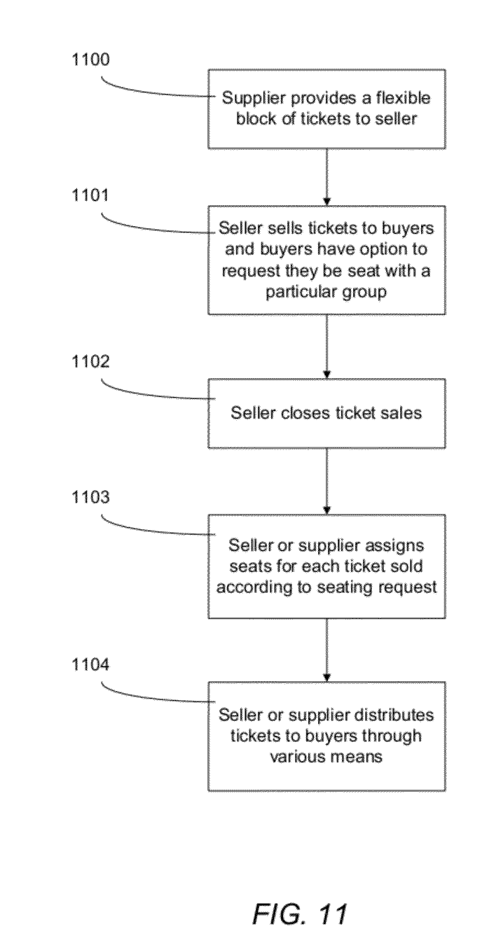

In summary, FIG. 11 is a high level block diagram showing the process according to various embodiments of the present disclosure. The ticket supplier for a particular event allocates the ticket seller with a set amount (e.g., an inventory) of tickets (1100) that the ticket seller can sell to buyers (1101). Although each ticket is guaranteed a seat in a specific section/tier at the event, the specific seat within the section/tier is not provided to the buyers until the tickets are no longer available for sale (e.g., sold out, or after a set cut-off time before the start of the event) by the seller (1102). Thus, the seller is allocated a flexible block of ticket inventory to sell and assign seats as desired. Once sale of the tickets is closed, the ticket seller or the ticket supplier can assign specific seats to each of the individual tickets that were sold (1103) and then distribute such tickets to any of the buyers according to the methods described herein (1104). Since the specific seats are not assigned to the tickets until ticket sales are closed, when the group size of the buyers changes (e.g., additional friends later decide they want to also attend the event with the group), the buyer's entire group is able to sit together at the event, as already described in the embodiments of the present disclosure.

The examples set forth above are provided to give those of ordinary skill in the art a complete disclosure and description of how to make and use the embodiments of the methods of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A computer-based method of selling tickets to a plurality of buyers, the method comprising:
providing a seller with a plurality of event tickets to be sold;
providing a server based Internet website for selling the plurality of the event tickets;
a first person purchasing one or more event tickets by visiting the server based Internet website using an Internet browser from a client terminal connected to an Internet network;
the server storing the event ticket information of the first person in a will-call database;
the server providing a purchase identifier to the first person after the purchasing of the one or more event tickets, wherein the purchase identifier is linked to the event ticket information of the first person;
sharing the purchase identifier with at least one other person, the at least one other person desiring to purchase a same event ticket and desiring to sit with the first person;
the at least one other person visiting the server based Internet website by using the purchase identifier, wherein the server based Internet website identifies the at least one other person as desiring to sit with the first person according to the purchase identifier; and
the at least one other person purchasing the event ticket while visiting the server based Internet website, such that the event ticket information of the at least one other person is stored in the will-call database comprising instructions to seat the first person and the at least one other person together.

2. The method according to claim 1, wherein the purchase identifier is a unique purchase uniform resource locator (URL) or an alphanumeric code.

3. The method according to claim 2, further comprising directing the at least one other person directly to the server based Internet website when the at least one other person clicks on the shared unique purchase URL.

4. The method according to claim 2, further comprising the at least one other person inputs the alphanumeric code upon visiting the server based Internet website.

5. The method according to claim 1, wherein the sharing the purchase identifier is performed by the first person, the at least one other person, the server, or a combination thereof.

6. The method according to claim 1, further comprising:
the server generating a will-call list based on information comprised in the will-call database; and
the seller providing the will-call list to a ticket supplier of the event to which the event ticket pertains.

7. The method according to claim 6, wherein the ticket supplier is the seller.

8. The method according to claim 6, further comprising: the ticket supplier assigning seats for the tickets purchased by the first person and the at least one other person according to instructions provided in the will-call list.

9. The method according to claim 1, further comprising:
the seller assigning seats for the tickets purchased by the first person and the at least one other person according to instructions in a will-call database.

10. The method according to claim 1, wherein the sharing the purchase identifier is shared by email, instant messages, blogs, or social media websites.

11. A computer server for selling tickets, comprising:
a website adapted to sell one or more event tickets to a plurality of buyers, wherein the website is configured to enable a first buyer to purchase one or more event tickets, wherein a purchase identifier is provided to the first buyer upon purchase, such that the purchase identifier is shareable with at least one other buyer; and
a will-call database comprising information of the first buyer and the at least one other buyer, wherein the will-call database is configured to provide a will-call list to a ticket supplier of the event, the will-call list comprising instruction to seat the first buyer with the at least one other buyer.

12. A system for selling tickets over an Internet network, comprising:
a server connected to the Internet network, the server comprising a website adapted to sell one or more event tickets to a plurality of buyers;
a first client terminal connected to the Internet network and adapted to be used by a first buyer, the first client terminal comprising hardware and software, such that the first buyer is able to visit the website on the server;
the website adapted to enable the first buyer to purchase an event ticket, such that a purchase identifier is provided to the first buyer, wherein the purchase identifier is shareable with at least one other buyer;
one or more additional client terminals connected to the Internet network, the one or more additional client terminals adapted to be used by the at least one other buyer to purchase a same event ticket as the first buyer and desiring to sit with the first buyer, the one or more additional client terminals comprising hardware and software, such that the at least one other buyer is able to use the purchase identifier to visit the website, wherein the purchase identifier identifies the at least one other buyer as desiring to sit with the first buyer; and
a will-call database associated with the server comprising information of the first buyer and the at least one other buyer, wherein the will-call database is configured to provide a will-call list to a ticket supplier of the event associated with the event ticket comprising instruction to seat the first buyer with the at least one other buyer.

13. A method of sharing a purchase identifier among a plurality of buyers, the method comprising the steps of:
generating, by a server, the purchase identifier when a first buyer purchases one or more event tickets, the purchase identifier adapted to associate one or more additional buyers with the first buyer;
providing, by the first buyer, the purchase identifier to the one or more additional buyers;
purchasing, by the one or more additional buyers, one or more event tickets using the purchase identifier; and
associating the one or more additional buyers with the first buyer, wherein the associating comprises assigning seating for the first buyer with the one or more additional buyers.

14. The method according to claim 13, wherein the first buyer providing the purchase identifier to the one or more additional buyers further comprises:
providing, by the first buyer, one or more email addresses of the one or more additional buyers to the server; and
sending, by the server, an email comprising the purchase identifier to each of the one or more additional buyers.

15. The method according to claim 13, wherein the first buyer providing the purchase identifier to the one or more additional buyers further comprises:
emailing, by the first buyer, the purchase identifier to the one or more additional buyers or posting the purchase identifier to a social media website.

16. The method according to claim 13, the first buyer and the one or more additional buyers purchase event tickets through a ticket seller's website.

17. The method according to claim 13, wherein the purchase identifier is a unique purchase uniform resource location (URL) or an alphanumeric code.

18. A method for selling event tickets, comprising:
a supplier allocating a plurality of tickets to a seller, the seller selling the plurality of tickets on a webpage accessible by buyers from the Internet, wherein each ticket of the plurality of tickets is a reservation for a seat at the event;
a server selling at least one ticket of the plurality of tickets to a first buyer thus reserving a seat from the allocated plurality of tickets without a specific seat assignment;
the server selling at least one additional ticket of the plurality of tickets to at least one additional buyer thus reserving a seat from the allocated plurality of tickets without a specific seat assignment, wherein the at least one additional buyer desires to sit with at least the first buyer;
stopping selling the plurality of tickets; and
the seller or the supplier assigning a specific seat to each of the plurality of tickets sold to the first buyer and the at least one additional buyer upon stopping selling the plurality of ticket, thus assigning seats according to the seating assignment desires by the first buyer and the additional buyers.

19. The method according to claim 18, further comprising the first buyer or the at least one additional buyer obtaining the event tickets from the seller or the supplier in-person at the event, via a delivery courier, or via a postal service.

20. The method according to claim 18, further comprising the first buyer or the at least one additional buyer obtaining the event tickets from the seller or the supplier in a form of electronic event tickets via email or the Internet.
